(19) United States
(12) Patent Application Publication
(10) Pub. No.: US 2025/0233335 A1
(43) Pub. Date: Jul. 17, 2025

(54) Connector Terminal and Connector

(71) Applicants: SIBAS Electronics (Xiamen) Co. Ltd., Xiamen City (CN); Tyco Electronics (Shanghai) Co., Ltd., Shanghai (CN)

(72) Inventors: Qiang Yuan, Xiamen (CN); Liqiang (Gino) Yao, Shanghai (CN); Yong (Chris) Wang, Shanghai (CN); Lei Wang, Xiamen (CN); Xiangshui Su, Xiamen (CN)

(73) Assignees: SIBAS Electronics (Xiamen) Co. Ltd., Xiamen City (CN); Tyco Electronics (Shanghai) Co., Ltd., Shanghai (CN)

(21) Appl. No.: 19/022,602

(22) Filed: Jan. 15, 2025

(30) Foreign Application Priority Data
Jan. 15, 2024 (CN) 202420095545.4

(51) Int. Cl. H01R 13/11; H01R 13/424

(52) U.S. Cl. CPC H01R 13/11; H01R 13/424

(57) ABSTRACT

A connector terminal includes a cylindrical body having a front end and a rear end opposite the front end in an axial direction, an annular portion in front of the cylindrical body and axially opposite to the cylindrical body, a plurality of first spring arms connected between the cylindrical body and the annular portion and distributed at intervals in a circumferential direction of the cylindrical body, and a plurality of second spring arms extending forward from the front end of the cylindrical body and distributed at intervals in the circumferential direction of the cylindrical body. The first spring arms are each a simply supported beam and the second spring arms are each a cantilever beam. The first spring arms and the second spring arms are alternately arranged in the circumferential direction of the cylindrical body and simultaneously electrically contact an outer circumferential surface of an inserted mating terminal.

### CROSS-REFERENCE TO RELATED APPLICATION

This application claims the benefit of the filing date under 35 U.S.C. § 119(a)-(d) of Chinese Patent Application No. 202420095545.4, filed on Jan. 15, 2024.

### FIELD OF THE INVENTION

The present invention relates to a connector terminal and a connector comprising the connector terminal.

### BACKGROUND OF THE INVENTION

There are usually two structures for terminals in heavy-duty connectors, one is a fully cantilevered beam structure, and the other is a fully simply supported beam structure. The terminal of the full cantilever beam structure is prone to deformation, which can lead to poor electrical contact and instability. The terminal of the fully supported beam structure has too much or too little insertion and extraction force when mated with the mating terminal, which is difficult to control, and the size of the terminal product is relatively large.

### SUMMARY OF THE INVENTION

A connector terminal includes a cylindrical body having a front end and a rear end opposite the front end in an axial direction, an annular portion in front of the cylindrical body and axially opposite to the cylindrical body, a plurality of first spring arms connected between the cylindrical body and the annular portion and distributed at intervals in a circumferential direction of the cylindrical body, and a plurality of second spring arms extending forward from the front end of the cylindrical body and distributed at intervals in the circumferential direction of the cylindrical body. The first spring arms are each a simply supported beam and the second spring arms are each a cantilever beam. The first spring arms and the second spring arms are alternately arranged in the circumferential direction of the cylindrical body and simultaneously electrically contact an outer circumferential surface of an inserted mating terminal.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector terminal according to an exemplary embodiment of the present invention when viewed from one angle;

FIG. 2 shows an illustrative perspective view of a connector terminal according to an exemplary embodiment of the present invention when viewed from another angle;

FIG. 3 shows an axial sectional perspective view of a connector terminal according to an exemplary embodiment of the present invention; and

FIG. 4 shows an axial sectional plan view of a connector according to an exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

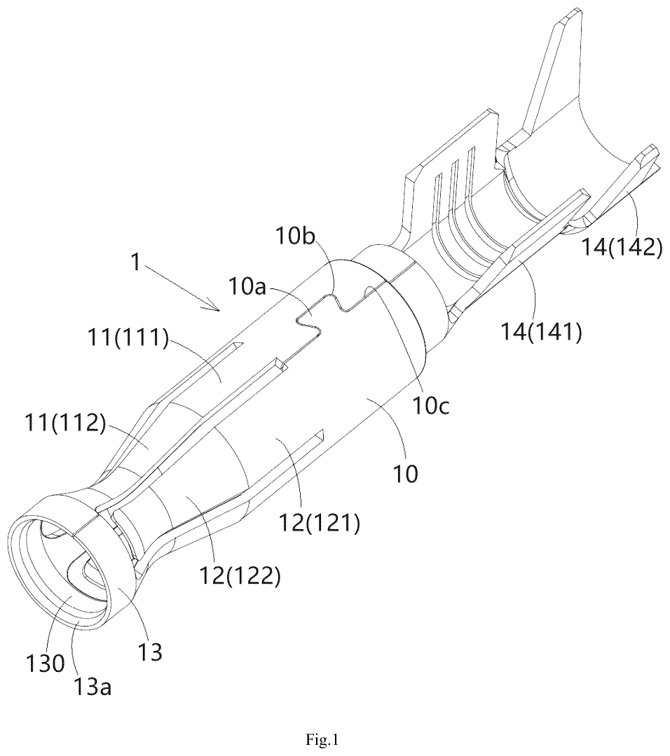

As shown in FIGS. 1 to 3, in an exemplary embodiment of the present invention, a connector terminal 1 is disclosed. The connector terminal 1 includes a cylindrical body 10, an annular portion 13, a plurality of first spring arms 11, and a plurality of second spring arms 12.

The cylindrical body 10 has front and rear ends that are opposite in its axial direction. The annular portion 13 is located in front of the cylindrical body 10 and axially opposite to the cylindrical body 10. Multiple first spring arms 11 are connected between the cylindrical body 10 and the annular portion 13 and distributed at intervals in the circumferential direction of the cylindrical body 10. Multiple second arms 12 extend forward from the front end of the cylindrical body 10 and are distributed at intervals in the circumferential direction of the cylindrical body 10.

The two ends of the first spring arm 11 are respectively connected to the cylindrical body 10 and the annular portion 13, making the first spring arm 11 a simply supported beam. One end of the second spring arm 12 is connected to the cylindrical body 10, and the other end is suspended, making the second spring arm 12 a cantilever beam. The first spring arm 11 and the second spring arm 12 are alternately arranged in the circumferential direction of the cylindrical body 10, for simultaneous electrical contact with the outer circumferential surface of a mating terminal of an inserted mating connector.

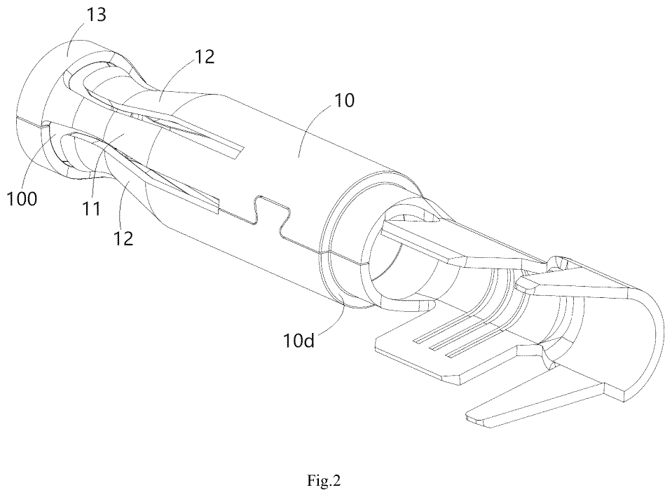

As shown in FIG. 2, in the illustrated embodiment, a window 100 is formed among the annular portion 13 and adjacent two first spring arms 11, and each second spring arm 12 is suspended in a corresponding window 100.

As shown in FIGS. 1 to 3, in the illustrated embodiment, the annular portion 13 is coaxial with the cylindrical body 10, and the diameter of the annular portion 13 is smaller than that of the cylindrical body 10. The annular portion 13 has a front opening 130, shown in FIG. 1, that allows for the insertion of the mating terminal, and a conical guide surface 13a is formed on the inner side of the front opening 130 of the annular portion 13 to guide the insertion of the mating terminal.

As shown in FIGS. 1 to 3, in the illustrated embodiment, the front and rear ends of the first spring arm 11 are respectively connected to the annular portion 13 and the cylindrical body 10, and a first contact portion 11a protruding inward is formed on the front end of the first spring arm 11. The rear end of the second arm 12 is connected to the cylindrical body 10 and a second contact portion 12a protruding inward is formed on the inner side of the front end of the second arm 12. When the mating terminal is inserted into connector terminal 1, the first contact portions 11a of multiple first spring arms 11 and the second contact portions 12a of multiple second spring arms 12 surround the mating terminal and make electrical contact with the outer peripheral surface of the mating terminal simultaneously.

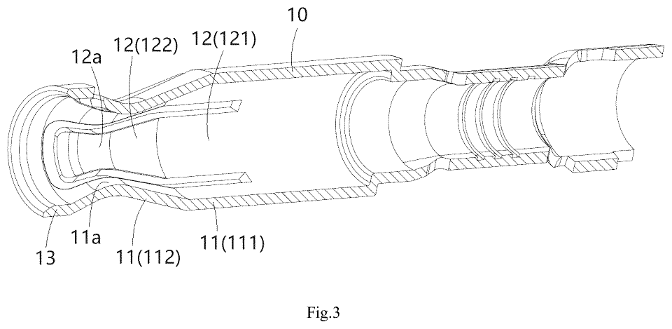

As shown in FIGS. 1 and 3, in the illustrated embodiment, the first spring arm 11 includes a first axial extension arm 111 and a first inclined extension arm 112. The rear end of the first axial extension arm 111 is connected to the front end of the cylindrical body 10, the first axial extension arm 111 extends forward along the axial direction of the cylindrical body 10. The rear end of the first inclined extension arm 112 is connected to the front end of the first axial extension arm 111, the first inclined extension arm 112 extends obliquely forward relative to the axial direction of the cylindrical body 10. The front end of the first inclined extension arm 112 is connected to the annular portion 13, and the first contact portion 11a is formed on the inner side of the front end of the first inclined extension arm 112.

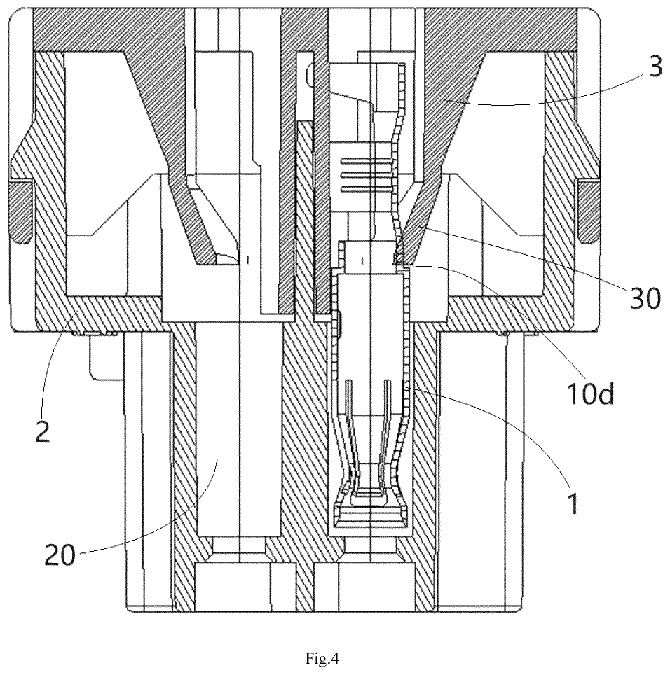

As shown in FIGS. 1 to 3, in the illustrated embodiment, the second spring arm 12 includes a second axial extension arm 121 and a second inclined extension arm 122. The rear end of the second axial extension arm 121 is connected to the front end of the cylindrical body 10 and the second axial extension arm 121 extends forward along the axial direction of the cylindrical body 10. The rear end of the second inclined extension arm 122 is connected to the front end of the second axial extension arm 121 and the second inclined extension arm 122 extends obliquely forward relative to the axial direction of the cylindrical body 10. The front end of the second inclined extension arm 122 is suspended, and the second contact portion 12a is formed on the inner side of the front end of the second inclined extension arm 122. As shown in FIGS. 2 and 4, in the illustrated embodiment, a circular positioning step 10d is formed on the outer side of the rear end of the cylindrical body 10.

As shown in FIG. 1, in the illustrated embodiment, the connector terminal 1 further includes a crimping part 14, which is connected to the rear end of the cylindrical body 10 for crimping onto and electrical connection with a cable. The crimping part 14 includes a first crimping part 141 and a second crimping part 142. The first crimping part 141 is U-shaped and suitable for crimping onto the conductor core of the cable. The second crimping part 142 is U-shaped and suitable for crimping onto the outer layer of the cable. The first crimping part 141 is connected between the rear end of the cylindrical body 10 and the second crimping part 142.

In the illustrated embodiment, the connector terminal 1 is an integral stamped piece. This can reduce manufacturing costs and improve production efficiency.

As shown in FIGS. 1 to 3, in the illustrated embodiment, the cylindrical body 10 has two longitudinally extending side edges 10c spliced together. An engagement protrusion 10a is form on one side edge 10c of the cylindrical body 10, and an engagement slot 10b is formed on the other side edge 10c of the cylindrical body 10. The engagement protrusion 10a is engaged with the engagement slot 10b. In various embodiments, the engagement protrusion 10a and the engagement slot 10b are in a dovetail shape, an inverted triangle shape, or an Ω shape, so that the engagement protrusion 10a and the engagement slot 10b cannot be separated in the circumferential direction of the cylindrical body 10.

As shown in FIG. 4, in another exemplary embodiment of the present invention, a connector is also disclosed. The connector includes the connector housing 2 and the above connector terminal 1. A terminal hole 20 is formed in the connector housing 2. The connector terminal 1 is inserted into the terminal hole 20.

As shown in FIG. 4, in the illustrated embodiment, the connector further comprises a locking component 3, which is installed in the connector housing 2 and formed with a locking spring 30. The locking spring 30 extends into the terminal hole 20 and rests or presses against the positioning step 10d of the cylindrical body 10 of the connector terminal 1 to lock the connector terminal 1 in the connector housing 2.

In the aforementioned exemplary embodiments according to the present invention, the terminal has alternately arranged first and second spring arms 11, 12, with the first spring arm 11 being a simply supported beam and the second spring arm 12 being a cantilever beam. This hybrid structure of simply supported beam and cantilever beam can improve the electrical contact reliability and stability of the terminals 1, reduce the size of the terminals 1, lower the manufacturing cost of the terminals 1, and reduce the insertion and extraction force during terminal mating.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A connector terminal, comprising:
a cylindrical body having a front end and a rear end opposite the front end in an axial direction;
an annular portion in front of the cylindrical body and axially opposite to the cylindrical body;
a plurality of first spring arms connected between the cylindrical body and the annular portion and distributed at intervals in a circumferential direction of the cylindrical body, a pair of ends of each of the first spring arms are respectively connected to the cylindrical body and the annular portion, the first spring arms are each a simply supported beam; and
a plurality of second spring arms extending forward from the front end of the cylindrical body and distributed at intervals in the circumferential direction of the cylindrical body, an end of each of the second spring arms is connected to the cylindrical body and another end of each of the second spring arms is suspended, the second spring arms are each a cantilever beam, the first spring arms and the second spring arms are alternately arranged in the circumferential direction of the cylindrical body and simultaneously electrically contact an outer circumferential surface of an inserted mating terminal.

2. The connector terminal according to claim 1, wherein a window is formed among the annular portion and a pair of adjacent first spring arms of the plurality of first spring arms, one of the second spring arms is suspended in the window.

3. The connector terminal according to claim 1, wherein the annular portion and the cylindrical body are coaxial.

4. The connector terminal according to claim 1, wherein a diameter of the annular portion is smaller than a diameter of the cylindrical body.

5. The connector terminal according to claim 1, wherein the annular portion has a front opening receiving the inserted mating terminal, a conical guide surface is formed on an inner side of the front opening of the annular portion to guide the inserted mating terminal.

6. The connector terminal according to claim 1, wherein each of the first spring arms has a first contact portion protruding inward, the first contact portion is formed on a front end of the first spring arm.

7. The connector terminal according to claim 6, wherein the end of each of the second spring arms connected to the cylindrical body is a rear end of the second spring arms, each of the second spring arms has a second contact portion protruding inward and formed on an inner side at a front end of the second spring arm.

8. The connector terminal according to claim 7, wherein, when the inserted mating terminal is inserted into the connector terminal, the first contact portions of the first spring arms and the second contact portions of the second spring arms surround the inserted mating terminal and simultaneously electrically contact the outer circumferential surface of the inserted mating terminal.

9. The connector terminal according to claim 8, wherein each of the first spring arms includes:
a first axial extension arm having a rear end connected to the front end of the cylindrical body and extending forward along the axial direction of the cylindrical body; and
a first inclined extension arm having a rear end connected to a front end of the first axial extension arm and extending obliquely forward relative to the axial direction of the cylindrical body, a front end of the first inclined extension arm is connected to the annular portion, and the first contact portion is formed on an inner side of the front end of the first inclined extension arm.

10. The connector terminal according to claim 8, wherein each of the second spring arms includes:
a second axial extension arm having a rear end connected to the front end of the cylindrical body and extending forward along the axial direction of the cylindrical body; and
a second inclined extension arm having a rear end connected to a front end of the second axial extension arm and extending obliquely forward relative to the axial direction of the cylindrical body, a front end of the second inclined extension arm is suspended, and the second contact portion is formed on the inner side of the front end of the second inclined extension arm.

11. The connector terminal according to claim 1, wherein a circular positioning step is formed on an outer side of the rear end of the cylindrical body, the circular positioning step abuts against a locking spring of a locking component inside a connector housing to lock the connector terminal in the connector housing.

12. The connector terminal according to claim 1, further comprising a crimping part connected to the rear end of the cylindrical body and crimping onto a cable for electrical connection with the cable.

13. The connector terminal according to claim 12, wherein the crimping part includes:
a first crimping part that is U-shaped and crimps onto a conductor core of the cable; and
a second crimping part that is U-shaped and crimps onto an outer layer of the cable, the first crimping part is connected between the rear end of the cylindrical body and the second crimping part.

14. The connector terminal according to claim 1, wherein the connector terminal is an integral stamped piece.

15. The connector terminal according to claim 14, wherein the cylindrical body has a pair of longitudinally extending side edges that are spliced together, an engagement protrusion is formed on one of the longitudinally extending side edges and an engagement slot is formed on the other of the longitudinally extending side edges, the engagement protrusion is engaged with the engagement slot.

16. The connector terminal according to claim 15, wherein the engagement protrusion and the engagement slot are in a dovetail shape, an inverted triangle shape, or an Ω shape, and the engagement protrusion and the engagement slot cannot be separated in the circumferential direction of the cylindrical body.

17. A connector, comprising:
a connector housing having a terminal hole; and
a connector terminal inserted into the terminal hole, the connector terminal including:
a cylindrical body having a front end and a rear end opposite the front end in an axial direction;
an annular portion in front of the cylindrical body and axially opposite to the cylindrical body;
a plurality of first spring arms connected between the cylindrical body and the annular portion and distributed at intervals in a circumferential direction of the cylindrical body, a pair of ends of each of the first spring arms are respectively connected to the cylindrical body and the annular portion, the first spring arms are each a simply supported beam; and
a plurality of second spring arms extending forward from the front end of the cylindrical body and distributed at intervals in the circumferential direction of the cylindrical body, an end of each of the second spring arms is connected to the cylindrical body and another end of each of the second spring arms is suspended, the second spring arms are each a cantilever beam, the first spring arms and the second spring arms are alternately arranged in the circumferential direction of the cylindrical body and simultaneously electrically contact an outer circumferential surface of an inserted mating terminal.

18. The connector according to claim 17, further comprising a locking component installed in the connector housing and having a locking spring, the locking spring extends into the terminal hole and abuts against a positioning step of the cylindrical body to lock the connector terminal in the connector housing.
